(19) United States
(12) Patent Application Publication
(10) Pub. No.: US 2018/0293643 A1
(43) Pub. Date: Oct. 11, 2018

(54) LOCATION AWARE SHOPPING LIST

(71) Applicant: International Business Machines Corporation, Armonk, NY (US)

(72) Inventors: Mark T. Allen, Toronto (CA); Scott M. Guminy, Newmarket (CA)

(21) Appl. No.: 15/484,257

(22) Filed: Apr. 11, 2017

(51) Int. Cl. G06Q 30/06

(52) U.S. Cl. CPC G06Q 30/0639; G06Q 30/0633

(57) ABSTRACT

A computing method receives a shopping list, a GPS location, and products offered at a store. The computing method classifies each shopping list item into one or more hierarchies with an associated confidence level. The computing method determines one or more items corresponding to hierarchies where confidence level that exceeds the predetermined threshold level. The computing method determines a user location and a store within a predefined range of the user location. The computing method determines whether the store includes any of the one or more items and sends a notification to the user including an identification of the store and the item at the store.

### BACKGROUND OF THE INVENTION

The present invention relates generally to improved data processing operations, and more particularly to mechanisms for providing cognitive techniques for shopping list applications.

Consumers often compile shopping lists as a reminder of the items or services they need to purchase on their next visit to brick and mortar stores. For example, it is common for consumers to compile shopping lists of items they need to buy from stores as varied as grocery, clothing, hardware, and even technology stores. Shopping lists are often compiled as the need for an item arises in day to day activities and mobile device technology has, for the most part, replaced the traditional scrap piece of paper shopping list by providing tools for crafting shopping lists. These tools range from simple text editors to specialized shopping list applications.

Mobile device technology also includes global positioning system (GPS) capabilities that enable location aware services for users. GPS devices operate based on a satellite navigation system that provides location and time information anywhere there is unobstructed line of sight access to four or more GPS satellites. The GPS satellite system is maintained by the United States government, and is accessible to anyone with a GPS receiver. Location aware services use location data of a user, and other data to control features of an application, and often combine a location data of a user with information gathered from certain databases to provide additional location information for the user.

### SUMMARY

Embodiments of the present invention disclose a method, a computer program product, and a system for a location-aware shopping list. The method for a location aware shopping list includes one or more processors that receive a shopping list including one or more shopping list items. One or more processors classify each item shopping list item of one or more shopping list items into one or more hierarchies using a predetermined taxonomy classification. One or more processors determine a confidence level associated with each hierarchy of the one or more hierarchies and determine whether the confidence level associated with any hierarchy of the one or more hierarchies exceeds a predetermined threshold level. One or more processors determine all the shopping list items in the one or more hierarchies with the confidence level that exceeds the predetermined threshold level. One or more processors determine a user location and a store within a predefined range of the user location. One or more processors determine whether the store includes any of the one or more items and send a notification to the user, including an identification of the store and the one or more items at the store.

### BRIEF DESCRIPTION OF THE DRAWINGS

FIG. 1 is a functional block diagram illustrating a distributed data processing environment, in accordance with an embodiment of the present invention;

FIG. 2 is a flowchart depicting operational steps of a location aware shopping list program, on a server computer within the distributed data processing environment of FIG. 1, in accordance with an embodiment of the present invention;

FIG. 3A is a flowchart depicting operational steps of an aspect of the location aware shopping list program, on the server computer within the distributed data processing environment of FIG. 1, in accordance with an embodiment of the present invention;

FIG. 3B is a flowchart depicting operational steps of an aspect of the location aware shopping list program, on the server computer within the distributed data processing environment of FIG. 1, in accordance with an embodiment of the present invention; and

FIG. 4 depicts a block diagram of components of the server computer executing the location aware shopping list analysis program within the distributed data processing environment of FIG. 1, in accordance with an embodiment of the present invention.

### DETAILED DESCRIPTION

A typical shopping list application provides the capability to include items that a user wants to purchase. The shopping list serves as an organizer for the items as well as a reminder to buy the listed items. Embodiments of the present invention recognize that users tend to forget to purchase items on the shopping list and further recognize that users are not always aware of the brick and mortar store locations that carry the items that they want to purchase. Yet other embodiments recognize that users often use imprecise high level concepts to describe items on a shopping list. Some embodiments recognize that, while some items are typically found at most stores, users may want to be notified of items that are hard to find, item variations, or items that are otherwise not readily available at locations known by the user. Still other embodiments recognize that user behavior can be gathered directly or inferred from a variety of sources to understand and anticipate user needs and preferences as shopping lists are processed.

To overcome these challenges, embodiments of the present invention allow the user to submit a shopping list, crafted using any user preferred application, and to process the shopping list using natural language processing and cognitive computing capabilities. By leveraging natural language processing, location based services, and cognitive computing, users may be notified of nearby stores offering the products that the user is interested in, with minimal manual user input beyond creating the shopping list. Using these techniques, users are not required to enter items on the shopping list in any predetermined way since items on the shopping list are identified using general, imprecise, or even slang terms.

Natural language processing (NLP) refers to computer implemented techniques to understand written or spoken natural languages such as English. Natural language understanding (NLU) techniques focus on machine reading comprehension. As used in this disclosure, NLP and NLU techniques are employed to understand the contents of a shopping list. In some embodiments of the present invention, a taxonomy classification is performed to obtain one or more hierarchies of categories related to the each of the shopping list entries plus a corresponding confidence level is determined for each resulting category. The corresponding confidence level for each result enables a determination of whether the identified category is a poor, good, or best fit for shopping list entries. The hierarchies can be used to determine the category of products that the user wants to buy, and therefore identify the stores that carry the shopping list products, based on available inventory data from the stores. In other embodiments, entity analysis may be performed to identify product names, brands, stores, and/or locations contained in the shopping list. NLP and NLU techniques may also be used in cognitive capabilities to understand high level, result based shopping list entries, in which shopping list items are determined by use of expert sources and/or user history, such as determining ingredients for a recipe.

Location based services commonly found in modern mobile devices may be used to identify brick and mortar stores nearby to the location of the user. An embodiment of this disclosure receives a mobile device location and finds brick and mortar stores within a predefined range from the user of the mobile device.

Cognitive computing capability refers to computer implemented techniques that mimic human thought processes with the goal of aiding users in decision making. By determining an understanding of text or audio content from NLP, analyzing available structured and unstructured data, and applying contextual conditions, cognitive computing generates confidence levels associated with results to establish a poor, good, or best recommendation. In relation with embodiments of the present invention, cognitive computing refers to applications, or components of applications that learn by consumption of a corpus of information, such as using supervised and/or unsupervised machine learning techniques, as well as neural network techniques, and continue to learn as additional information becomes available, as well as when goals or requirements change. Cognitive computing applications may also continuously interact with users and other computers, devices, data sources, and services (e.g., social media). Cognitive computing also enables applications to understand contextual elements by extracting information from a variety of sources.

Implementation of embodiments of the present invention may take a variety of forms, and exemplary implementation details are discussed subsequently with reference to the Figures.

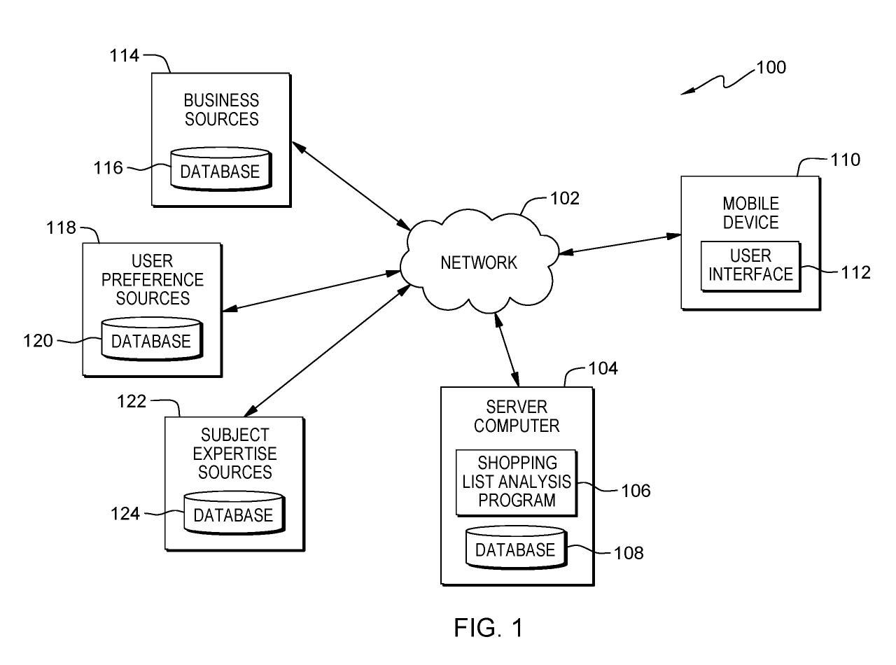

FIG. 1 is a functional block diagram illustrating a distributed data processing environment, generally designated 100, in accordance with one embodiment of the present invention. The term “distributed” as used in this specification describes a computer system that includes multiple, physically distinct devices that operate together as a single computer system. FIG. 1 provides only an illustration of one implementation and does not imply any limitations regarding the environments in which different embodiments may be implemented. Many modifications to the depicted environment may be made by those skilled in the art without departing from the scope of the invention as recited by the claims.

Distributed data processing environment 100 includes server computer 104, mobile device 110, business sources 114, user preference sources 118, and subject expertise sources 122, all interconnected over network 102.

In general, network 102 can be any combination of connections and protocols that will support communications between server computer 104, mobile device 110, business sources 114, user preference sources 118, and subject expertise sources 122, and other computing devices (not shown) within distributed data processing environment 100. Network 102 can be, for example, a telecommunications network, a local area network (LAN), a wide area network (WAN), such as the Internet, or a combination of the three, and can include wired, wireless, or fiber optic connections. Network 102 can include one or more wired and/or wireless networks that can receive and transmit data, voice, and/or video signals, including multimedia signals that include voice, data, and video information.

Mobile device 110 enables a user to input a shopping list using a preferred application (not shown) and to submit the shopping list to shopping list analysis program 106. Mobile device 110 sends the location of the mobile device 110 to shopping list analysis program 106. Mobile device 110 further receives notification of available products in nearby stores corresponding to items on the shopping list. In some embodiments of the present invention, mobile device 110 is a device that performs programmable instructions and may include access to location based services and mapping services. For example, mobile device 110 can be a laptop computer, a tablet computer, a smart phone, or any programmable electronic mobile device capable of communicating with various components and devices within distributed data processing environment 100, via network 102. In general, mobile device 110 represents any programmable electronic mobile device or combination of programmable electronic mobile devices capable of executing machine readable program instructions and communicating with other computing devices (not shown) within distributed data processing environment 100 via a network, such as network 102. Mobile device 110 includes an instance of user interface 112.

User interface 112 provides an interface to shopping list analysis program 106 on server computer 104 for a user of mobile device 110. In some embodiments of the present invention, user interface 112 may be a graphical user interface (GUI) or a web user interface (WUI) and can display text, documents, web browser windows, user options, application interfaces, instructions for operation, and include the information (such as graphic, text, and sound) that a program presents to a user and the control sequences the user employs to control the program. In other embodiments, user interface 112 may also be mobile application software that provides an interface between a user of mobile device 110 and server computer 104. Mobile application software, or an “app,” is a computer program designed to run on smart phones, tablet computers and other mobile devices. User interface 112 enables the user of mobile device 110 to input a shopping list to be processed by shopping list analysis program 106 to enable location based notifications of the availability of items included in the shopping list. In accordance with some embodiments, users input the shopping list by interaction with user interface 112, which may include touch screen devices, audio capture devices, and other types of user interfaces. In other embodiments, user interface 112 may be an external device operatively connected to mobile device 110 via near-field communication or other types of wired and/or wireless technologies.

Server computer 104 includes shopping list analysis program 106 and database 108. Shopping list analysis program 106 provides location based brick and mortar store recommendations to users based on items added to the shopping list. Shopping list analysis program 106 receives a shopping list from mobile device 110 and performs natural language processing techniques, including taxonomy classification, to classify the shopping list entries into a taxonomic hierarchy of categories, coupled with a confidence level for each category result. For example, a shopping list including drinks such as “Soft Drink A” or “Soft Drink B” may return a taxonomic classification of “/food and drink/beverages/nonalcoholic beverages/soft drinks.” In this example, this taxonomic classification may be used to identify stores that carry “soft drinks” to offer store recommendations for the user.

Shopping list analysis program 106 may also perform entity extraction on the shopping list entries. Extracting entity information allows shopping list analysis program 106 to identify entities (e.g., company names, organizations, geographic locations, concepts, and locations, among other entities) to increase accuracy of the store recommendations made to the user. For example, if the shopping list includes an entry such as “Brand X TV,” shopping list analysis program 106 extracts entity information and identifies “Brand X” as an entity for purposes of store recommendation. Similarly, shopping list analysis program 106 may further perform keyword extraction to identify keywords in the shopping list entries. Other NLP, NLU, and cognitive techniques may be performed to identify the contents of the shopping list.

Shopping list analysis program 106 further receives a location of mobile device 110. Shopping list analysis program 106 uses the hierarchy of categories of products obtained from the shopping list, and the corresponding confidence levels generated for each of the categories, in combination with the location data of mobile device 110 to determine nearby brick and mortar stores that carry the products the user wishes to buy. To identify the nearby brick and mortar stores that carry the desired products, shopping list analysis program 106 receives the location of mobile device 110 and queries business sources 114 to determine the location and inventory of nearby brick and mortar stores that carry the categories of products described in the shopping list entries. Relating to a previous example, a shopping list including an item such as “Soft Drink A” or “Soft Drink B” may return the taxonomic hierarchy “/food and drink/nonalcoholic beverages/soft drinks” with a corresponding confidence level of 0.80. In an embodiment of the present invention, the taxonomic ranks in the hierarchy of categories may be used to narrow store recommendations. For example, store recommendations in this example may be narrowed to stores that carry “food and drink” products and, in particular, to stores that carry “nonalcoholic beverages,” such as grocery stores. In another embodiment, once nearby stores matching the taxonomic hierarchy are identified, shopping list analysis program 106 performs a search of the store inventory using the inferior rank in the taxonomic hierarchy. In this example, shopping list analysis program 106 searches the inventory of nearby stores for “soft drinks” products, as the inferior rank in the taxonomic hierarchy.

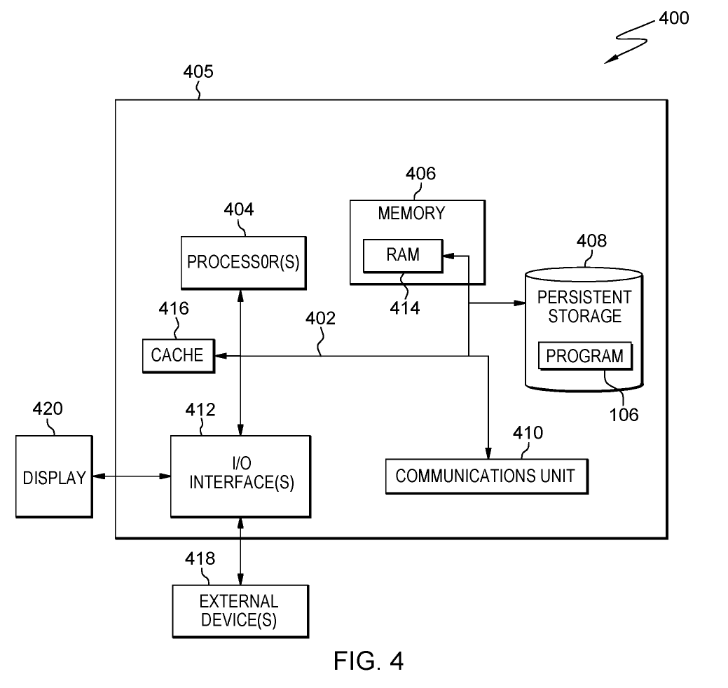

Server computer 104 can be a standalone computing device, a management server, a web server, a mobile computing device, or any other electronic device or computing system capable of receiving, sending, and processing data. In other embodiments, server computer 104 can represent a server computing system utilizing multiple computers as a server system, such as in a cloud computing environment. In another embodiment, server computer 104 can be a laptop computer, a tablet computer, a netbook computer, a personal computer (PC), a desktop computer, a personal digital assistant (PDA), a smart phone, or any other programmable electronic device capable of communicating with mobile device 110, business sources 114, user preference sources 118, subject expertise sources 122, and other computing devices (not shown) within distributed data processing environment 100 via network 102. In another embodiment, server computer 104 represents a computing system utilizing clustered computers and components (e.g., database server computers, application server computers, etc.) that act as a single pool of seamless resources when accessed within distributed data processing environment 100. Server computer 104 may include internal and external hardware components, as depicted and described in further detail with respect to FIG. 4.

Database 108 is a repository for data used by shopping list analysis program 106. Data used by shopping list analysis program 106 may include the shopping list, the taxonomic classification of the shopping list of items, the entity information related to the shopping list of items, and any other information related to the shopping list of items. In the depicted embodiment, database 108 resides on server computer 104. In another embodiment, database 108 may reside elsewhere within distributed data processing environment 100 provided shopping list analysis program 106 has access to database 108.

In some embodiments of the present invention, business sources 114 may include a general purpose search engine. In other embodiments, business sources 114 may include a specialized search engine for store inventories. In yet other embodiments, business sources 114 may include the actual store website including product detail and inventory information. In still other embodiments, business sources 114 may obtain data from general purpose search engines, specialized search engines, and/or store websites to compile an inventory per store location to be stored in database 116. Database 116 can be implemented with a type of storage device capable of storing product inventory and description data, such as a hard disk drive or solid state drive on a database server, and configuration files that can be accessed and utilized by business sources 114.

In some embodiments of the present invention, shopping list analysis program 106 also queries subject expertise sources 122 to accurately determine individual items associated with high level shopping list entries. For example, a shopping list may include an entry of a high level, result based concept such as “make chocolate chip cookies.” In this example, shopping list analysis program 106 identifies that the user wishes to make homemade chocolate chip cookies instead of buying premade chocolate chip cookies. Shopping list analysis program 106 identifies the hierarchy of categories related to the entry and queries one of the plurality of subject expertise sources related to food recipes to identify the ingredients necessary for homemade chocolate chip cookies. Shopping list analysis program 106 may then provide store recommendations based on the identified ingredients. Although this example is related to food recipes, shopping list analysis program 106 may also query other domain specific knowledge websites such as do it yourself websites, recipe websites, fashion websites, music websites, and any other website that shows or teaches subject expertise in an area related to high level shopping list entries.

In some embodiments, subject expertise sources 122 may include a general purpose search engine. In other embodiments, subject expertise sources 122 may include a special purpose search engine for domain specific knowledge sites. In yet other embodiments, subject expertise sources 122 may include a specific website including detailed information related to the subject expertise applicable to the shopping list entry. For example, subject expertise sources 122 may include do it yourself websites, recipe websites, fashion websites, and any other website that shows or teaches subject expertise in an area related to the shopping list entries. In still other embodiments, subject expertise sources 122 may obtain data from general purpose search engines, specialized search engines, and/or subject expertise websites to compile domain specific knowledge of areas related to the shopping list entries to be stored in database 124. Database 124 can be implemented with any type of storage device capable of storing data and configuration files that can be accessed and utilized by subject expertise sources 122, such as a database server, a hard disk drive, or a flash memory.

Shopping list analysis program 106 may further query user preference sources 118 to provide refined shopping list entries based on user preferences and/or behavior. For example, a shopping list may include a shorthand entry to an item such as “milk” without providing a preference over the many brands and/or types of milk (e.g., whole milk, nonfat milk, flavored milk, almond milk, soy milk, rice milk, etc.). In this example, shopping list analysis program 106 queries user preference sources 118 to identify user provided preferences that are stated or can be inferred by past user behavior. For example, if shopping list analysis program 106 identifies that the user prefers almond milk, based on user feedback or past behavior, the shopping list entry “milk” is refined to “almond milk.” In some embodiments, the refined shopping list item “almond milk” may be included on the shopping list, in addition to the generic listing of “milk”. Shopping list analysis program 106 may also provide store recommendations based on user preferences. Although this example is related to foods, shopping list analysis program 106 may also seek user preferences related to other types of shopping list entries.

In some embodiments of the present invention, user preference sources 118 may include a list of items previously bought by the user by querying sources such as loyalty programs or by allowing the user to input lists of previously bought items such as providing store receipts or any other type of acknowledgment of the previously bought items. User preferences may be obtained directly from the user, inferred from user behavior, or by performing NLP and NLU techniques (e.g., sentiment analysis) on a source document. In some embodiments, user preference sources 118 may include one or more social media websites, from which user product preferences may be determined. In other embodiments, user preference sources 118 may include a loyalty program having a list of user preferences and/or a list of items previously bought by the user. In yet other embodiments, user preference sources 118 may include inquiring user preferences or feedback as to the refined product list provided. For example, shopping list analysis program 106 refines the list into a more accurate list based on the user preference sources 118. If the user does not prefer the refined item, shopping list analysis program 106 learns from the user preference (e.g., by user behavior of not selecting the refined item) and will not subsequently suggest the refined item. Shopping list analysis program 106 may also present the user with a refined product list. In this case, the user may select the proper refined item from the refined product list. Shopping list analysis program 106 may use the selected refined item in the future. In still another embodiment, user preferences learned over time may be stored in database 120. Database 120 can be implemented with type of storage device capable of storing product inventory and description data, such as a hard disk drive or solid state drive on a database server, and configuration files that can be accessed and utilized by business sources 114.

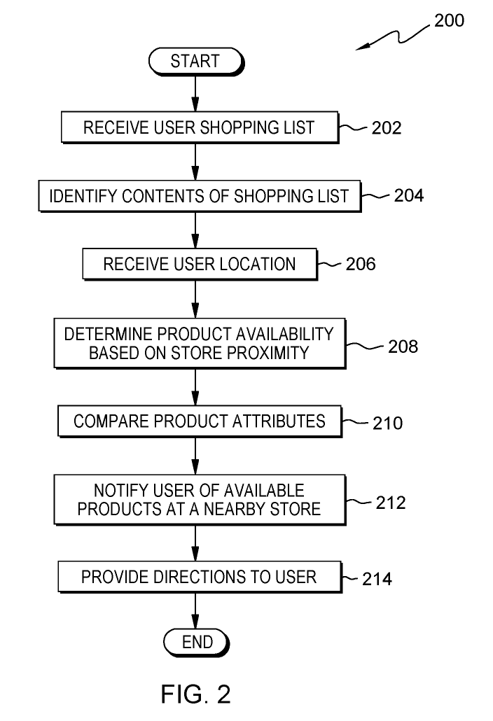

FIG. 2 depicts flowchart 200, illustrating operational steps of shopping list analysis program 106, operating on server computer 104, within distributed data processing environment 100 of FIG. 1, in accordance with an embodiment of the present invention. Shopping list analysis program 106 receives a shopping list (step 202). The shopping list may be crafted at mobile device 110 using any preferred application and sent, or made accessible, to shopping list analysis program 106. Shopping list analysis program 106 may store the shopping list in database 108. The shopping list may further be modified by adding, removing, and/or updating items through user interface 112 of mobile device 110 and sending the updated shopping list to shopping list analysis program 106. In some embodiments, shopping list analysis program 106 may retrieve the shopping list stored on database 108 and update the entries accordingly.

Shopping list analysis program 106 identifies the contents of the shopping list (step 204). Shopping list analysis program 106 applies taxonomy classification to identify a hierarchy of categories. The hierarchy of categories may be initially selected from a predefined taxonomy classification, which may be continuously updated from text corpora. The taxonomy classification returns a hierarchy of categories with a corresponding level of confidence for each entry of the shopping list. The confidence level is associated with the extent to which the shopping list item is properly categorized. In some embodiments of the present invention, the confidence level must exceed a predefined threshold indicating a level of confidence that the category accurately aligns with the entry item of the shopping list. If shopping list analysis program 106 determines the confidence level to exceed the predefined threshold shopping list analysis program 106 initiates a search for nearby stores that include in their inventory, categories of items aligning with the shopping list entries. Therefore, if the confidence level of a determined category does not exceed the predefined threshold, the category is removed from consideration while searching for nearby stores. In some embodiments, the confidence level is calculated in accordance to the term frequency-inverse document frequency (TF-IDF) or any other statistical measure useful to evaluate the importance of a word in relation to a document in a collection or corpus.

In another embodiment, shopping list analysis program 106 further performs entity analysis to identify entities in the shopping list entries (e.g., product names, brands, locations, stores, among others). Referring to a previous example, a shopping list containing the entry “Brand X TV” will be related to the entity “Brand X.” The identified entity may be used to refine store recommendations to the user.

In yet another embodiment, shopping list analysis program 106 requests user feedback regarding identified shopping list entries to achieve higher accuracy in recommending a store providing the shopping list entries. For example, a shopping list contains the entries “Settlers of Catan” and “Power Grid.” Shopping list analysis program 106 may classify the items as “/hobbies and interests/games/board games and puzzles” with a confidence level of 0.7071 and “/business and industrial/energy/electricity” with a confidence level of 0.5900. Narrowing the categories into items available at stores, shopping list analysis program 106 may present the user a clarifying feedback inquiry of: “Are these items related to board games?” in user interface 112. Shopping list analysis program 106 may also present the user a clarifying feedback inquiry of: “Are these items related to electricity?” in user interface 112. If the user answers “Yes” as to board games and “No” as to electricity, shopping list analysis program 106 narrows the taxonomic hierarchy associated with the shopping list items to the “/hobbies and interests/games/board games and puzzles” category and provides only recommendations for stores carrying board games. In some embodiments, shopping list analysis program 106 uses the taxonomic categories in the hierarchy to narrow the store recommendations by using superior categories (e.g., “hobbies and interests” and “games”) to identify the types of stores that carry the shopping list items and inferior categories (e.g., “board games and puzzles”) to identify products within a store.

In yet another embodiment, shopping list analysis program 106 retrieves user preferences from user preference sources 118. Referring to the previous example, shopping list analysis program 106 may access the previous purchases of a user from user preference sources 118 and determine that the user has purchased board games within the last month. Based on this information, shopping list analysis program 106 may narrow the category associated with the shopping list items to the “/hobbies and interests/games/board games and puzzles” category without asking for user feedback. In another example, a shopping list may include a shorthand entry to an item such as “hot dog buns” without providing a preference over the many brands, or may include an entry of “milk” without information such as types of milk (e.g., gluten free, whole grain, honey wheat, potato bread, etc.). In this example, shopping list analysis program 106 queries user preference sources 118 to identify user provided preferences that are stated or can be inferred by past user behavior. If shopping list analysis program 106 identifies that the user routinely buys gluten free products, shopping list analysis program 106 may refine the product list to gluten free hot dog buns. Shopping list analysis program 106 may also provide store recommendations based on the preferences of the user. For example, if the user routinely buys a category of products at a particular store, shopping list analysis program 106 may narrow product recommendations to only those products available at the user preferred store. In some embodiments, the user preference sources 118 may be accessed only after the user provides consent to access those sources to protect the privacy of the preferences and purchase habits of the user.

In still another embodiment, shopping list analysis program 106 identifies a high level objective, or concept shopping list entry (also referred to as a high-level, result-based entry, such as “make chocolate chip cookies”). Shopping list analysis program 106 determines the entry meaning, and queries subject expertise sources 122 to determine the products associated with the high-level shopping list entry, and provides product recommendations based on the results obtained from subject expertise sources 122.

In a further embodiment, shopping list analysis program 106 performs disambiguation techniques to provide accurate product recommendations. For example, a user may provide an ambiguous shopping list entry such as “draft snake.” In this case, shopping list analysis program 106 performs disambiguation using the hierarchy of categories plus the corresponding confidence level to identify that a “draft snake” is an item related to hardware stores used to prevent drafts from spaces at the bottom of doors, as opposed to pet shops. Shopping list analysis program 106 may also request user feedback to determine correctness of the retrieved categories.

Shopping list analysis program 106 receives the location of the user (step 206). The present invention uses location based services and mapping services on mobile device 110 to obtain the mobile device 110 location, and send it to shopping list analysis program 106 for further processing. For example, a user may be travelling while mobile device 110 sends periodical location based responses to requests from shopping list analysis program 106. The user may also manually trigger a location based request from mobile device 110. Location based requests provide shopping list analysis program 106 with the location of the user to enable location based product recommendations in stores nearby the user. The location based requests may include, without limitation, a coordinate location, a geographic range, an address, a location (such as identification of a shopping mall), or a route.

Shopping list analysis program 106 uses the location of the user to determine product availability based on store proximity (step 208). The user location and/or store proximity may include locations within a predefined geographic range, or driving distance from the user. The user location and/or store proximity may also include locations within a predefined geographic range from a user provided route. A beneficial feature of embodiments of the present invention is that the user only needs to provide a shopping list using plain, natural language, or even a high level objective, and enable location services on their mobile device. Users may take advantage of various embodiments without the need to set specific geo location reminders or specific entry formats. Shopping list analysis program 106 uses the categories having the highest confidence levels and the products that match those categories to identify nearby stores. If a category has a low confidence level (such as failing to exceed a predefined threshold level), the category is not used when searching for stores that include the same or similar categories of products in their available inventories. In some embodiments, the products in the list of available products may include product attributes. In yet other embodiments, product availability of store inventories may be determined by relying on industry wide categories of consumer products. In still other embodiments, shopping list analysis program 106 may identify nearby stores, retrieve a list of products offered for sale at a nearby store, and apply NLP techniques of taxonomy classification, entity analysis, and keyword extraction to the retrieved list of products, to determine a hierarchy of categories related to the products sold at the store. In response, shopping list analysis program 106 may compare the hierarchy of categories related to the shopping list entries to the hierarchy of categories related to the products sold at the store to determine product availability based on determined categories of shopping list entries and store inventory, and store proximity.

Having determined store proximity and product availability, shopping list analysis program 106 compares product attributes (step 210). For example, shopping list analysis program 106 may have identified multiple available products in stores nearby the user. Shopping list analysis program 106 retrieves the information for each of the available products and compares product attributes (such as, price, color, status, sizes, brands, among others) with respect to the user preferences. Referring to a previously presented example, if shopping list analysis program 106 identifies that the user routinely buys gluten free products, shopping list analysis program 106 may narrow the refined product list to gluten free hot dog buns. Shopping list analysis program 106 may also provide store recommendations based on user preferences and/or the purchase history of the user. For example, if the user routinely buys a category of products in a particular store, shopping list analysis program 106 may narrow product recommendations to only those products available at the user preferred store. Product attributes may also be used to remove an available product for failure to meet user preferences and/or previously provided feedback from the user. Since the user may be in transit, shopping list analysis program 106 may advantageously present the order of the list of available products based on store proximity.

Shopping list analysis program 106 notifies the user of the available products at a nearby store (step 212). In an embodiment of the present invention, shopping list analysis program 106 may send an ordered list of the available products, including the store, and store location, to a mobile device 110 to be displayed in user interface 112. In another embodiment, shopping list analysis program 106 may send an alert to the user, while providing means for the user to view the available products (such as a hyperlink). In yet another embodiment, shopping list analysis program 106 may use a mapping service on mobile device 110 to display a location of a store offering the available products. In still another embodiment, shopping list analysis program 106 may notify the user of the availability of a product in a store that is located along a user provided route. Shopping list analysis program 106 may provide the option to the user to add the store location to the user provided route.

Having provided a notification of shopping list items available in stores in the proximity of the user, shopping list analysis program 106 may provide directions to nearby stores selling an available product corresponding to an entry of the shopping list (step 214). For example, shopping list analysis program 106 may receive a request for directions to a particular available product. In response to such request, shopping list analysis program 106 retrieves the store floor plan and product location from available information of the plurality of business sources 114 and provides directions to the available product location within the store associated with the location of the mobile device.

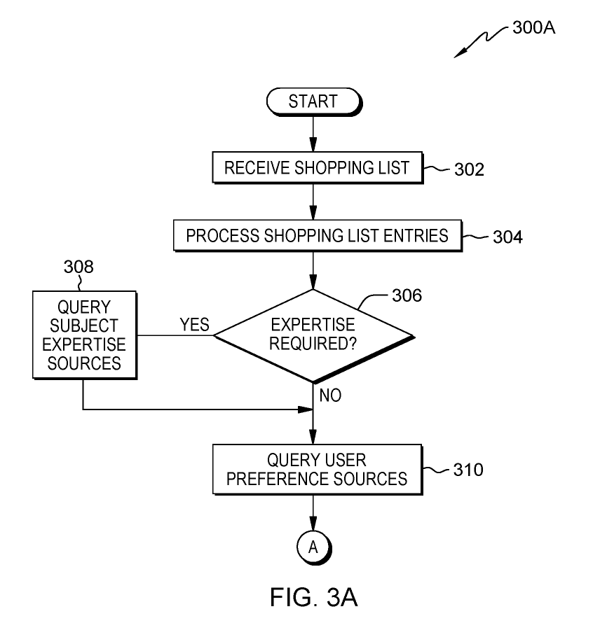

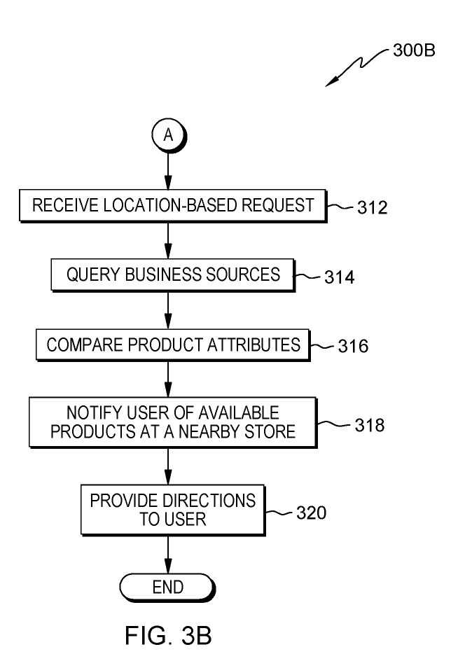

FIG. 3A depicts flowchart 300A and FIG. 2 depicts flowchart 300B, illustrating additional aspects of operational steps of shopping list analysis program 106, operating on server computer 104 within distributed data processing environment 100 of FIG. 1, in accordance with an embodiment of the present invention. FIG. 3A depicts flowchart 300A and FIG. 2 depicts flowchart 300B, showing a more detailed flowchart depicting the integration of shopping list analysis program 106 with respect to the business sources 114, user preference sources 118, and subject expertise sources 122.

Referring to FIG. 3A, shopping list analysis program 106 receives a shopping list (step 302). As described with respect to FIG. 2, the shopping list may be crafted at mobile device 110 using any preferred application and sent to shopping list analysis program 106. Shopping list analysis program 106 may store the shopping list in database 108. The shopping list may further be modified by adding, removing and/or updating items at mobile device 110 and sending the updated shopping list to shopping list analysis program 106. In some embodiments, shopping list analysis program 106 may retrieve the stored shopping list from database 108 and update the entries accordingly.

Shopping list analysis program 106 processes the shopping list entries using NLP and NLU techniques including, without limitation, taxonomy classification and entity analysis (step 304). As discussed with respect to FIG. 2, shopping list analysis program 106 receives a shopping list from mobile device 110 and performs natural language processing techniques, including taxonomy classification, to classify the shopping list entries into a hierarchy of categories coupled with a confidence level for each category result. Shopping list analysis program 106 may also extract entity information on the shopping list entries to identify brands, locations, among other entities. Similarly, shopping list analysis program 106 may further perform keyword extraction to identify keywords in the shopping list entries. Other NLP and NLU techniques may be performed to identify the contents of the shopping list.

Shopping list analysis program 106 may also identify whether a shopping list entry is a higher level objective or concept for which expertise is required to determine the component requirements and provide product recommendations (decision step 306). Shopping list analysis program 106 applies cognitive functions to determine the objective desired by the high level objective item. Cognitive functions may include performing NLP and semantic analysis to determine the objective of the shopping list item, and based on the objective, determine whether expertise is required to identify items associated with performing the objective. As previously discussed, the shopping list may include an entry of a high level (result or objective based item) concept such as “make chocolate chip cookies.”

For the case in which shopping list analysis program 106 applies cognitive functions to the shopping list entries and determines that expertise is not required (step 306, “NO” branch), shopping list analysis program 106 proceeds to query user preference sources (step 310), discussed in detail below. For the case in which expertise is required (step 306, “YES” branch), shopping list analysis program 106 queries subject expertise sources (step 308). In response to determining the entry meaning, shopping list analysis program 106 determines the category of the concept and determines whether the concept can be further expanded or described by a list of shopping list items. To achieve this objective, shopping list analysis program 106 may query subject expertise sources 122 and extract possible products that the user would be interested in buying based on the higher level objective shopping list entry. In the previously presented example, shopping list analysis program 106 identifies that the user wishes to make chocolate chip cookies instead of buying premade chocolate chip cookies. Shopping list analysis program 106 identifies the hierarchy of categories related to the entry and queries one or more of subject expertise sources 122 related to food recipes to identify the ingredient items necessary to make chocolate chip cookies, and performs a taxonomy classification applying categories to the determined ingredient items.

Shopping list analysis program 106 further queries user preference sources 118 to determine user preferences in relation to the shopping list entries (step 310). User preference sources 118 may include social media websites, store loyalty programs, or any source from which user history or behavior as to the shopping list entries may be obtained or inferred. As previously discussed, a shopping list may include a shorthand entry to an item such as “milk” without providing a preference over the many brands and/or types of milk (e.g., whole milk, nonfat milk, flavored milk, almond milk, soy milk, rice milk, etc.). In this example, shopping list analysis program 106 queries a plurality of user preference sources 118 to identify user provided preferences or a user preference that can be inferred by past user behavior. Shopping list analysis program 106 may then provide store recommendations based on the user preferences.

Referring to FIG. 3B, shopping list analysis program 106 receives a location based request (step 312). As discussed with respect to FIG. 2, the present invention uses location based services and mapping services on mobile device 110 to obtain the mobile device 110 location and send it to the shopping list analysis program 106 for further processing. For example, a user may be travelling while mobile device 110 sends periodical location based data in response to requests from shopping list analysis program 106. The user may also trigger a location based request from mobile device 110. Location based requests provide shopping list analysis program 106 with the location of the user to enable location based product recommendations in stores nearby the user. The location based requests may include, without limitation, a coordinate location, a geographic range, a location (such as identification of a shopping mall), or a route. Shopping list analysis program 106 may continue to gather information related to the shopping list items, such as subject expertise or user preferences, between periods of user location update.

Shopping list analysis program 106 queries business sources 114 to determine availability of the shopping list entries close to the provided location (step 314). Shopping list analysis program 106 uses the hierarchy of categories of products obtained from applying a predefined classification taxonomy to items on the shopping list, and the corresponding confidence levels of the categories (as previously described with respect to FIG. 2), in combination with the location data of mobile device 110 to query store inventories and determine nearby brick and mortar stores that carry the products the user wishes to buy. To identify the nearby brick and mortar stores that carry the desired products, shopping list analysis program 106 receives the location of mobile device 110 and queries the plurality of business sources 114 to determine the location and inventory of nearby brick and mortar stores that carry the products related to the shopping list entries. In some embodiments, product availability may be determined by relying on industry wide categories of consumer products. In still other embodiments, shopping list analysis program 106 may identify nearby stores, retrieve a list of products offered for sale at a store, and apply NLP techniques to the retrieved list of products, such as taxonomy classification, entity analysis, and keyword extraction, to determine a hierarchy of categories related to the products sold at the store. Shopping list analysis program 106 may compare the hierarchy of categories related to the shopping list entries to the hierarchy of categories related to the products sold at the store to determine product availability associated with store proximity.

Shopping list analysis program 106 determines the available products and compares the product attributes (step 316). As previously discussed, shopping list analysis program 106 may have identified multiple available products in stores nearby the user. Shopping list analysis program 106 retrieves the information for each of the available products and compares product attributes (such as, price, color, status, sizes, brands, among others) with respect to the user preferences. Referring to a previously provided example, if shopping list analysis program 106 identifies that the user routinely buys gluten free products, shopping list analysis program 106 may narrow the product recommendations of “hot dog buns” to gluten free hot dog buns. Shopping list analysis program 106 may also provide store recommendations based on the user preferences. For example, if the user routinely buys a category of products in a particular store, shopping list analysis program 106 may narrow product recommendations to only those products available at the user preferred store. Product attributes may also be used to remove an available product from consideration for failure to meet user preferences and/or previously provided feedback from the user. Since the user may be in transit, shopping list analysis program 106 may advantageously arrange the order the list of available products based on store proximity.

Shopping list analysis program 106 notifies the user of available products at a nearby store (step 318). As previously discussed with respect to FIG. 2, in an embodiment of the present invention, having compared hierarchy of categories determined from the user shopping list and to inventories of nearby stores, shopping list analysis program 106 may send an ordered list of the available products to a mobile device 110, including identification of the store and store location, to be displayed in user interface 112. In another embodiment, shopping list analysis program 106 may send an alert to the user, while providing means for the user to view the available products (such as a hyperlink). In yet another embodiment, shopping list analysis program 106 may use a mapping service on mobile device 110 to display the nearby stores. In still another embodiment, shopping list analysis program 106 may notify that availability of a product along a predefined, user provided route. Shopping list analysis program 106 may provide the option to the user to add the location of the store to the user provided route.

If the selected store includes location information within the selected store, shopping list analysis program requests the location information of items on the shopping list available in the store and presents the location information to the user (step 320). For example, upon determining the user is driving to a recommended nearby store that carries at least one of the products on the user shopping list, shopping list analysis program 106 may retrieve the available product location within the store (if product location information within the store is available), and provide directions to the available product by including, for example, the aisle number where the available product is located. By way of illustration, shopping list analysis program 106 may retrieve the store floor plan and product location from the plurality of business sources 114 and provide on user interface 112 of mobile device 110, directions to the available product location within the store.

FIG. 4 depicts a block diagram of computer system 400, including components of computing device 405 which is similar to server computer 104, and capable of operating shopping list analysis program 106, within distributed data processing environment 100 of FIG. 1, in accordance with an embodiment of the present invention. It should be appreciated that FIG. 4 provides only an illustration of one implementation and does not imply any limitations with regard to the environments in which different embodiments can be implemented. Many modifications to the depicted environment can be made.

Computing device 405 and server computer 104 include communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer-readable storage media. In this embodiment, memory 406 includes random access memory (RAM) 414 and cache memory 416. In general, memory 406 can include any suitable volatile or non-volatile computer-readable storage media.

Shopping list analysis program 106 is stored in persistent storage 408 for execution by one or more of the respective computer processors 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer-readable storage medium that is also part of persistent storage 408.

Communications unit 410, in these examples, provides for communications with other data processing systems or devices, including resources of distributed data processing environment 100. In these examples, communications unit 410 includes one or more network interface cards. Communications unit 410 may provide communications through the use of either or both physical and wireless communications links. Shopping list analysis program 106 may be downloaded to persistent storage 408 through communications unit 410.

I/O interface(s) 412 allows for input and output of data with other devices that may be accessible to computing device 405 and server computer 104, such as mobile device 110, business sources 114, user preference sources 118, and subject expertise sources 122, and other computing devices (not shown). For example, I/O interface 412 may provide a connection to external devices 418 such as a keyboard, keypad, a touch screen, and/or some other suitable input device. External devices 418 can also include portable computer-readable storage media such as, for example, thumb drives, portable optical or magnetic disks, and memory cards. Software and data used to practice embodiments of the present invention, e.g., Shopping list analysis program 106 can be stored on such portable computer-readable storage media and can be loaded onto persistent storage 408 via I/O interface(s) 412. I/O interface(s) 412 also connect to a display 420.

Display 420 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method comprising:
receiving, by one or more processors, a shopping list, wherein the shopping list includes one or more shopping list items, wherein the shopping list includes a refined shopping list entry based on a first user preference, and wherein the first user preference is determined by performing sentiment analysis on a source document;
classifying, by one or more processors, each shopping list item of the one or more shopping list items into one or more hierarchies, wherein the classification is done using a predetermined taxonomy classification, and wherein the classification includes a confidence level associated with each hierarchy of the one or more hierarchies;
determining, by one or more processors, whether the confidence level associated with any hierarchy of the one or more hierarchies exceeds a predetermined threshold level;
determining, by one or more processors, one or more items, wherein the one or more items are all of the shopping list items in the one or more hierarchies with the confidence level that exceeds the predetermined threshold level;
determining, by one or more processors, a user location, wherein the user location is periodically determined by a location-based service;
determining, by one or more processors, a nearby store, wherein the nearby store is within a predefined driving distance of the user location;
determining, by one or more processors, one or more superior categories of the one or more hierarchies;
determining, by one or more processors, a store category corresponding to the one or more superior categories;
determining, by one or more processors, whether the nearby store matches the store category;
determining, by one or more processors, one or more inferior categories of the one or more hierarchies;
determining, by one or more processors, an item category corresponding to the one or more inferior categories;
determining, by one or more processors, whether the nearby store matches the item category;
responsive to determining the nearby store matches the store category and the item category, determining, by one or more processors, whether an inventory of the nearby store includes an item of the one or more items; and
responsive to determining the inventory of the nearby store includes the item of the one or more items, sending, by one or more processors, a notification to the user, wherein the notification includes an identification of the nearby store, a location of the nearby store, and the item of the one or more items at the nearby store.

2. The method of claim 1, wherein the step of classifying, by one or more processors, each shopping list item of one or more shopping list items into one or more hierarchies, wherein the classification is done using a predetermined taxonomy classification comprises:
determining, by one or more processors, whether a shopping list item of the one or more shopping list of items is a high-level, result-based item by semantic analysis;
responsive to determining the item of the shopping list of items is a high-level, result-based item, determining, by one or more processors, one or more component items of the high-level, result-based item using expertise sources; and
classifying, by one or more processors, each shopping list item of the one or more shopping list items and each component item of the one or more component items into one or more hierarchies, wherein the classification is done using a predetermined taxonomy classification.

3. The method of claim 1, wherein the step of determining, by one or more processors, one or more items, wherein the one or more items are all of the shopping list items in the one or more hierarchies with the confidence level that exceeds the predetermined threshold level comprises:
receiving, by one or more processors, a second user preference for a shopping list item of the one or more shopping list of items;
determining, by one or more processors, one or more refined items based on the second user preference; and
determining, by one or more processors, one or more items, wherein the one or more items includes the one or more refined items in the one or more hierarchies with the confidence level that exceeds the predetermined threshold level and all of the shopping list items in the one or more hierarchies with the confidence level that exceeds the predetermined threshold level.

4. The method of claim 1, wherein the step of determining, by one or more processors, one or more items, wherein the one or more items are all of the shopping list items in the one or more hierarchies with the confidence level that exceeds the predetermined threshold level comprises:
determining, by one or more processors, an entity information for each shopping list item of the one or more shopping list items;
determining, by one or more processors, one or more entity items based on the entity information; and
determining, by one or more processors, one or more items, wherein the one or more items includes the one or more entity items in the one or more hierarchies with the confidence level that exceeds the predetermined threshold level and all of the shopping list items in the one or more hierarchies with the confidence level that exceeds the predetermined threshold level.

5. (canceled)

6. (canceled)

7. The method of claim 1, further comprising:
receiving, by one or more processors, feedback from the user, wherein the feedback is related to the one or more hierarchies; and
updating, by one or more processors, the confidence level associated with each hierarchy of the one or more hierarchies.

8. A computer program product comprising:
one or more computer readable storage media; and
program instructions stored on the one or more computer readable storage media, the program instructions comprising:
program instructions to receive a shopping list, wherein the shopping list includes one or more shopping list items, wherein the one or more shopping list items includes a refined shopping list entry based on a first user preference, and wherein the first user preference is determined by performing sentiment analysis on a source document;
program instructions to classify each item shopping list item of one or more shopping list items into one or more hierarchies, wherein the classification is done using a predetermined taxonomy classification, and wherein the classification includes a confidence level associated with each hierarchy of the one or more hierarchies;
program instructions to determine whether the confidence level associated with any hierarchy of the one or more hierarchies exceeds a predetermined threshold level;
program instructions to determine one or more items, wherein the one or more items are all the shopping list items in the one or more hierarchies with the confidence level that exceeds the predetermined threshold level;
program instructions to determine a user location, wherein the user location is periodically determined by a location-based service;
program instructions to determine a nearby store, wherein a location of the nearby store is within a predefined driving distance of the user location;
program instructions to determine one or more superior categories of the one or more hierarchies;
program instructions to determine a store category corresponding to the one or more superior categories;
program instructions to determine whether the nearby store matches the store category;
program instructions to determine one or more inferior categories of the one or more hierarchies;
program instructions to determine an item category corresponding to the one or more inferior categories;
program instructions to determine whether the nearby store matches the item category;
program instructions to, responsive to determining the nearby store matches the store category and the item category, determine whether an inventory of the nearby store includes an item of the one or more items; and
program instructions to send a notification to the user, responsive to determining the inventory of the nearby store includes the item of the one or more items, wherein the notification includes an identification of the nearby store, the location of the nearby store, and the item of the one or more items at the nearby store.

9. The computer program product of claim 8, wherein the program instructions to classify each shopping list item of one or more shopping list items into one or more hierarchies, wherein the classification is done using a predetermined taxonomy classification comprises:
program instructions to determine whether a shopping list item of the one or more shopping list of items is a high-level, result-based item by semantic analysis;
program instructions to, responsive to determining the item of the shopping list of items is a high-level, result-based item, determine one or more component items of the high-level, result-based item using expertise sources; and
program instructions to classify each shopping list item of the one or more shopping list items and each component item of the one or more component items into one or more hierarchies, wherein the classification is done using a predetermined taxonomy classification.

10. The computer program product of claim 8, wherein the program instructions to determine one or more items, wherein the one or more items are all of the shopping list items in the one or more hierarchies with the confidence level that exceeds the predetermined threshold level comprises:
program instructions to receive a second user preference for a shopping list item of the one or more shopping list of items;
program instructions to determine one or more refined items based on the second user preference; and
program instructions to determine one or more items, wherein the one or more items includes the one or more refined items in the one or more hierarchies with the confidence level that exceeds the predetermined threshold level and all of the shopping list items in the one or more hierarchies with the confidence level that exceeds the predetermined threshold level.

11. The computer program product of claim 8, wherein the program instructions to determine one or more items, wherein the one or more items are all of the shopping list items in the one or more hierarchies with the confidence level that exceeds the predetermined threshold level comprises:
program instructions to determine an entity information for each shopping list item of the one or more shopping list items;
program instructions to determine one or more entity items based on the entity information; and
program instructions to determine one or more items, wherein the one or more items includes the one or more entity items in the one or more hierarchies with the confidence level that exceeds the predetermined threshold level and all of the shopping list items in the one or more hierarchies with the confidence level that exceeds the predetermined threshold level.

12. (canceled)

13. (canceled)

14. The computer program product of claim 8, further comprising program instructions, stored on the one or more computer readable storage media, to:
receive feedback from the user, wherein the feedback is related to the one or more hierarchies; and
update the confidence level associated with each hierarchy of the one or more hierarchies.

15. A computer system comprising:
one or more computer processors;
one or more computer readable media; and
program instructions, stored on the one or more computer readable media for execution by at least one of the one or more processors, the program instructions comprising:
program instructions to receive a shopping list, wherein the shopping list includes one or more shopping list items, wherein the one or more shopping list items includes a refined shopping list entry based on a first user preference, and wherein the first user preference is determined by performing sentiment analysis on a source document;
program instructions to classify each item shopping list item of one or more shopping list items into one or more hierarchies, wherein the classification is done using a predetermined taxonomy classification, and wherein the classification includes a confidence level associated with each hierarchy of the one or more hierarchies;
program instructions to determine whether the confidence level associated with any hierarchy of the one or more hierarchies exceeds a predetermined threshold level;
program instructions to determine one or more items, wherein the one or more items are all the shopping list items in the one or more hierarchies with the confidence level that exceeds the predetermined threshold level;
program instructions to determine a user location, wherein the user location is periodically determined by a location-based service;
program instructions to determine a nearby store, wherein a location of the nearby store is within a predefined driving distance of the user location;
program instructions to determine one or more superior categories of the one or more hierarchies;
program instructions to determine a store category corresponding to the one or more superior categories;
program instructions to determine whether the nearby store matches the store category;
program instructions to determine one or more inferior categories of the one or more hierarchies;
program instructions to determine an item category corresponding to the one or more inferior categories;
program instructions to determine whether the nearby store matches the item category;
program instructions to, responsive to determining the nearby store matches the store category and the item category, determine whether an inventory of the nearby store includes an item of the one or more items; and
program instructions to send a notification to the user, responsive to determining the inventory of the nearby store includes the item of the one or more items, wherein the notification includes an identification of the nearby store, the location of the nearby store, and the item of the one or more items at the nearby store.

16. The computer system of claim 15, wherein the program instructions to classify each shopping list item of one or more shopping list items into one or more hierarchies, wherein the classification is done using a predetermined taxonomy classification comprises:
program instructions to determine whether a shopping list item of the one or more shopping list of items is a high-level, result-based item by semantic analysis;
program instructions to, responsive to determining the item of the shopping list of items is a high-level, result-based item, determine one or more component items of the high-level, result-based item using expertise sources; and
program instructions to classify each shopping list item of the one or more shopping list items and each component item of the one or more component items into one or more hierarchies, wherein the classification is done using a predetermined taxonomy classification.

17. The computer system of claim 15, wherein the program instructions to determine one or more items, wherein the one or more items are all of the shopping list items in the one or more hierarchies with the confidence level that exceeds the predetermined threshold level comprises:
program instructions to receive a second user preference for a shopping list item of the one or more shopping list of items;
program instructions to determine one or more refined items based on the second user preference; and
program instructions to determine one or more items, wherein the one or more items includes the one or more refined items in the one or more hierarchies with the confidence level that exceeds the predetermined threshold level and all of the shopping list items in the one or more hierarchies with the confidence level that exceeds the predetermined threshold level.

18. The computer system of claim 15, wherein the program instructions to determine one or more items, wherein the one or more items are all of the shopping list items in the one or more hierarchies with the confidence level that exceeds the predetermined threshold level comprises:
program instructions to determine an entity information for each shopping list item of the one or more shopping list items;
program instructions to determine one or more entity items based on the entity information; and
program instructions to determine one or more items, wherein the one or more items includes the one or more entity items in the one or more hierarchies with the confidence level that exceeds the predetermined threshold level and all of the shopping list items in the one or more hierarchies with the confidence level that exceeds the predetermined threshold level.

19. (canceled)

20. The computer system of claim 15, further comprising program instructions, stored on the one or more computer readable media for execution by at least one of the one or more processors, to:
receive feedback from the user, wherein the feedback is related to the one or more hierarchies; and
update the confidence level associated with each hierarchy of the one or more hierarchies.
